(19) United States
(12) Patent Application Publication
(10) Pub. No.: US 2022/0177766 A1
(43) Pub. Date: Jun. 9, 2022

(54) COMPOSITE MATERIAL WITH ENHANCED THERMAL CONDUCTIVITY AND METHOD FOR FABRICATION THEREOF

(71) Applicant: ISRAEL AEROSPACE INDUSTRIES LTD., Lod (IL)

(72) Inventors: lsaschar GENISH, Gan Yavne (IL); Michael RISKIN, Jerusalem (IL); Yotam SCHATZBERG, Petah Tikva (IL); Oren REGEV, Lehavim (IL); Avia OHAYON, Dimona (IL); Matat BUZAGLO, Hadera (IL); Shani LIGATI, Binyamina (IL)

(21) Appl. No.: 17/437,601

(22) PCT Filed: Mar. 4, 2020
(86) PCT No.: PCT/IL2020/050243

§ 371 Date: Sep. 9, 2021

(30) Foreign Application Priority Data
Mar. 14, 2019 (IL) 265374

(51) Int. Cl. C09K 5/14; C08J 3/21; C08K 7/00; C08K 3/38

(52) U.S. Cl. CPC C09K 5/14; C08J 3/212; C08K 7/00; C08K 2003/385; C08J 2363/00; C08K 2201/003; C08K 3/38

(57) ABSTRACT

A composite member and a method for manufacturing polymeric material article are presented. The method comprising providing polymeric resin, providing selected amount of filler material, mixing filler material into the polymeric matrix to provide a polymeric filler mixture, compressing said polymeric filler mixture under pressure in the range of up to 350 bar, and curing said polymeric filler mixture to provide stable polymeric material. The resulting composite member is typically characterizes by having average filler to filler particle gap below 20 nm and substantially does not have air voids therein.

### TECHNOLOGICAL FIELD

The present invention is in the field of composite materials and specifically relates to composite materials with improved thermal conductivity.

### BACKGROUND

Composite and polymeric materials are used in various applications with high benefits. The use of such materials allows various improvements including miniaturization of electronic devices, as well as high compatibilization for use in different (including biological) environments. Physical properties of composite material may be tailored by various selections of polymer material and fillers, that provide enhanced structural and other physical characteristics to the composite article.

Thermosetting polymers are materials formed by hardening/curing resin or pre-polymer. Thermosetting polymers may often yield stronger materials, as compared to other plastic or polymer materials (e.g. thermoplastic materials), and may be further reinforced using selected fillers.

### GENERAL DESCRIPTION

There is a need to create polymer materials having desired weight and mechanical characteristics, while possessing improved thermal conductivity. The present technique utilizes selected fillers and manufacturing process in order to obtain polymer composite material exhibiting improved thermal conductivity, while maintaining ability to adjust the material's properties for desired applications.

The present technique utilizes pressure induced production of the polymer composite material for reducing filler-to-filler gaps and allows improved thermal conductivity of the material. To this end, using selected polymer matrix and filler materials, the present technique may provide resulting polymeric member exhibiting thermal conductivity of up to 27.5 W/mK. This is compared to the neat polymer matrix, having thermal conductivity of 0.2 W/mK. This improvement in thermal conductivity may answer crucial issues associated with the use of polymer materials in heat removal for high-power and/or high-frequency electronics, as well as in various additional applications, such as automotive, computers, hand held electronic devices etc.

Typically, the present technique may be most successfully implemented in fabrication of resin based thermosetting polymers. In such materials, the starting stage includes viscous liquid that can be mixed with the filler material and is malleable to adopt any form in which the polymer mixture is cured. This form may generally be dictated by a frame in which the corresponding blend is cured.

Generally, efficient heat dissipation allows to prevent device warming, generation of hot spots and life-time shortening of electronic devices. Heat can be removed by coupling the heat source to thermally conductive heat sink. The composite material and the technique described herein can provide effective lightweight polymeric replacement for heavy metal parts, such as metal fins. Polymer heat conducting material according to the present technique, may generally be lighter (e.g. about 50% lighter, as compared to metals), and may be molded into any selected form.

Typically, polymers exhibit much lower intrinsic thermal conductivities than those of carbon, metals or certain ceramic materials. For example, thermal conductivity of different polymer materials may vary in the range of 0.1-0.5 W/mK. Various techniques are used for improving thermal conductivity (TC) of elements formed from polymer materials, typically through using selected filler particles. Such filler particles are generally selected in accordance with structural, chemical and physical parameters, and may be used for determining selected physical characteristics to the resulting elements. For example, carbon-based graphitic nanofillers (NFs), such as graphite, graphene or carbon nanotubes, exhibit high TC values (typically above 2000 W/mK). Thus, these filler materials may be used for improving thermal conductivity of polymer elements. It should be noted, that the TC units designation W/mK stands for Watt·(meter)⁻¹·(temperature in Kelvin)⁻¹, or W·(m·K)⁻¹.

Carbon nanotubes have been studied and used for improving thermal conductivity of polymer composites. However, when used as fillers, the carbon nanotubes have been found to form loose junctions that scatter phonons, resulting in increase in local thermal resistance and, consequently, poor (i.e. low) TC values of the material. Filler's particle size may also affect the resulting TC of the composite material, where small-size fillers (<1 μm) have high surface area with respect to mass/volume ratio of the filler particles. Such fine fillers provide high filler-to-filler and filler-to-matrix interfacial contacts, increasing phonon scattering and thus limiting heat transfer, hence reducing the effective TC.

The inventors of the present invention have found that by using large-sized filler particles, i.e. determining average length dimension to be greater than 15 μm, combined with reducing filler-to-filler gap as described further below, yields reduced interfacial contacts, and allows enhancement of thermal conductivity of the so-formed material.

Accordingly, the present invention provides member, article or element formed of polymer material comprising selected fillers. The member of the invention yields improved thermal conductivity being greater than the 12 W/mK TC value of the resulting polymer element, as fabricated in the conventional techniques.

Thus, according to a broad aspect, the present invention provides a method for manufacturing polymeric material article, the method comprising providing polymeric resin, providing selected amount of filler material, mixing filler material into the polymeric matrix to obtain a polymeric filler mixture (blend), compressing said polymeric filler mixture under pressure in the range of up to 350 bar, and curing said polymeric filler mixture to provide stable polymeric material. The pressure used for compressing the polymeric filler mixture may preferably be greater than atmospheric pressure. The pressure may be between 20 bar and 350 bar.

According to some embodiments, the method may further comprise mixing hardening material into the said polymeric filler mixture (blend).

According to some embodiments, the method may further comprise placing the said polymeric filler mixture in low pressure condition for removing air voids prior to compressing the said polymeric filler mixture (blend).

According to some embodiments, said filler material may comprise carbon-based filler material. The carbon-based material may comprise at least one of graphite flakes and graphene platelets. Additionally or alternatively, the carbon-based material may comprise graphene platelets having average lateral dimension in the range 1-25 micrometer. Further additionally or alternatively, the carbon-based material may comprise graphite flakes having average lateral dimension in the range 20-250 micrometer. According to some embodiments, the filler material may comprise boron-nitride particles, thereby providing reduced electrical conductivity.

According to some embodiments, the selected amount of filler material may be at least 25 wt % with respect to the polymeric resin matrix. The selected amount of filler material may be in a range between 55 wt % and 80 wt % with respect to the polymeric resin matrix.

According to some embodiments, the method provides fabrication of thermosetting polymeric element having thermal conductivity exceeding 13 W/mK. The thermal conductivity of the polymer element may be in the range of 13-30 W/mK. In some configurations the thermal conductivity may exceed 16 W/mK.

According to an additional broad aspect, the present invention provides a composite member comprising hardened blend comprising epoxy resin and one or more types of filler particles, the composite member is characterized by having average filler-to-filler particle gap below 20 nm and substantially does not have air voids therein.

The composite member may be formed by applying pressure on wet mixture of the epoxy resin and one or more types of filler particles. The composite member may be formed by applying pressure in the range of 20 bar to 350 bar on wet mixture of the epoxy resin and one or more types of filler particles.

According to some embodiments, the mixture may further comprise hardening material provided for initiating and enhancing hardening of the epoxy resin.

According to some embodiments, the one or more types of filler particles comprise filler particles selected from: graphite flakes, graphene platelets and boron nitride particles. The graphite flakes may have average lateral dimension in the range of 20-250 micrometers. The graphene platelets may have average lateral dimension in the range of 1-25 micrometers.

According to some embodiments, the composite member may have thermal conductivity exceeding 13 W/mK. The thermal conductivity may exceed 16 W/mK, and/or be in the range of 13-30 W/mK.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows a flow chart indicating method of fabricating a composite article according to some embodiments of the present invention;

FIGS. 2A and 2B exemplify compression of polymer and filler mixture according to some embodiments of the present invention;

FIGS. 3A and 3B show scanning electron microscope (SEM) images of composite articles prepared without compression (FIG. 3A) and after compression of the mixture (FIG. 3B) according to some embodiments of the present invention;

FIG. 4 shows thermal conductivity measured on several samples having different filler loading ratios and prepared with selected compression levels according to some embodiments of the present invention;

FIGS. 5A to 5C show SEM images of filler particles, FIG. 5A shows graphite flakes, FIG. 5B shows graphene platelets and FIG. 5C shows boron nitride particles;

FIGS. 6A and 6B show thermal conductivity measurements on samples with different filler loading ratios, FIG. 6A shows TC measured on composite with graphite flakes at different loading ratios and FIG. 6B shows TC measured on composite with graphite flake and graphene platelets at different loading ratios;

FIG. 7 shows variation in TC enhancement for composite using different loading ratios of filler particles;

FIGS. 8A and 8B show TC enhancement measured on composite samples using boron nitride filler particles, FIG. 8A shows composite fabricated with no compression on the mixture and FIG. 8B shows TC variation with pressure applied on the mixture; and

FIG. 9 shows variation of TC enhancement for composite material using boron nitride filler particles of different sizes.

### DETAILED DESCRIPTION OF EMBODIMENTS

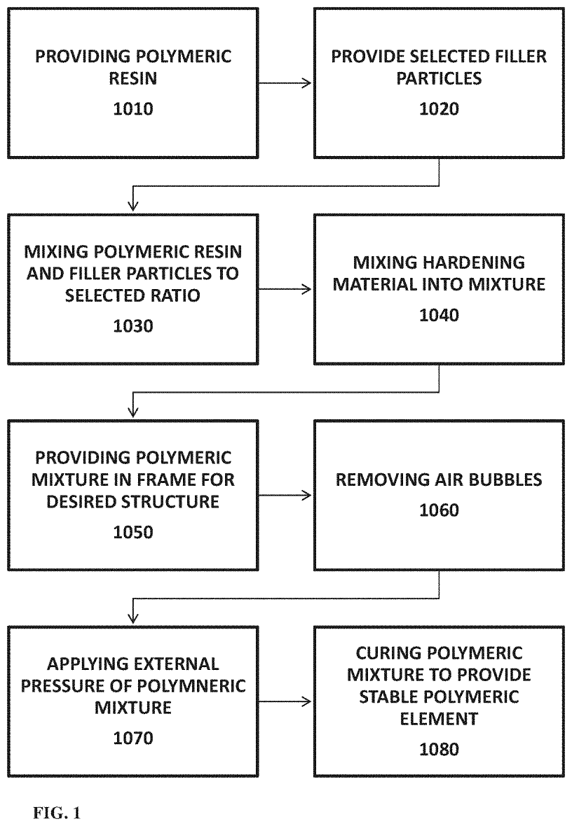

As indicated above, the present invention provides member formed of polymer resin and one or more filler materials and having improved thermal conductivity, and a technique for manufacturing of such member elements. To this end, the inventors of the present invention have found that applying high pressure on wet composite mixture, after preparation and mixing and before curing of the polymer resin. FIG. 1 is a flow diagram exemplifying manufacturing method according to some embodiments of the invention.

As shown in FIG. 1, the polymeric elements described herein are based on polymer resin material 1010, the polymer resin may be, for example, an epoxy resin, and may include diglycidyl ether of bisphenol A. Additionally, the technique utilizes selected filler materials, such as carbon-based particles, and/or boron nitride nanoparticles 1020, and mixing the filler material in selected quantities into the resin 1030. A hardening material, e.g. polyether triamine, is typically added to the polymer mixture 1040 to induce further hardening of the resin. On this stage the polymer mixture may solidify in time, under selected irradiation or heating. Prior to allowing/promoting solidification of the mixture, it may be placed in a frame providing desired structure of the so-formed element 1050. Air bubbles may be removed 1060 by vacuum suction for homogenizing the resulting composite structure. To attain improved thermal conductivity, the present technique utilizes applying external pressure on the mixture 1070, prior to curing 1080 or allowing the mixture to solidify. The pressure may be applied using selected weights or by providing the frame and the mixture therein within a press configured to apply high pressure on the mixture. Typically, the pressure may be applied by weighted piston, imparting additional pressure upon the blend. Such additional pressure is higher than atmospheric pressure and may preferably be up to 350 bar, and more preferably in the range of 22-350 bar. The pressure may be applied by increasing gas (air) pressure within a pressure chamber or by providing an external press or weight equivalent to the desired pressure, e.g. 20-356 Kg on each cm² of the mixture.

The selected filler material generally includes one or more types of selected particles based on thermal conductivity of the particles. Carbon based particles, such as carbon nanotubes, graphite flakes and graphene particles, exhibit thermal conductivity of over 2000 W/mK. In some embodiments, where the conflated elements are demanded to have limited or no electrical conductivity, the filler material may include boron-nitride particles (BNNP), as described in more details further below. Generally, the filler material is used at relatively high loading ratio, typically greater than 25 wt %. Preferably, the present technique utilizes filler loading ratio in a range of 55 wt % to 80 wt % for the total amount of filler particles used. Such high loading ratio may be considered to limit workability of the epoxy resin, as described in more details further below, the present technique overcomes this issue using the pressure applied on the mixture, sustaining sufficient workability at greater filler loading ratios.

As indicated above, heat removal may be a crucial issue in various applications, such as high-power high-frequency electronic industry. More specifically, efficient heat dissipation may be required during operation of various electronic devices to prevent device warming, generation of hot spots and heat damages that may shorten life-time of the device. Composite polymeric elements configured according to embodiments of the present technique, may be used for heat removal as a replacement for heavy metal parts such as fins or bulk metal heatsinks. Such polymeric heat conducting elements may advantageously be used in applications where lighter weight (˜50% compared to metals) and more facile processing and forming of the elements are required.

Generally, the intrinsic thermal conductivity of typical polymers is relatively low, ca. 0.2 W/mK, and is much lower than that of carbon, metals or various ceramic materials. The technique of the present invention utilizes addition of one or more types of fillers selected to provide improved thermal conductivity to the resulting composite elements. Among such thermally conductive filler particles are carbon-based graphitic nanofillers (NFs) that are formed of a single or multiple layers of carbon atoms (generally connected by sp² bonds). In some examples the selected filler particles include graphite and graphene particles. The thermal conductivity of these carbon-based NFs may exceed 2000 W/mK. Additional filler types identified by the inventors of the present invention include boron nitride nanoparticles (BNNP). The present technique may be used to provide either electrically and thermally conducting polymeric elements, e.g. using graphite and graphene filler particles, or electrically insulating and thermally conducting polymeric element, e.g. using boron nitride and graphene particles.

It should be noted, that generally carbon nanotubes (CNT) would be considered as efficient thermal conductivity enhancing fillers. This is in view of the high thermal conductivity of individual CNTs, being about 3000 W/mK. However, the inventors have found that, when used as filler particles, the CNT form loose junctions that scatter phonons resulting in increase in the local thermal resistance. Thus, the use of CNT fillers may bring merely limited improvement in thermal conductivity, as compared to graphite and graphene particles.

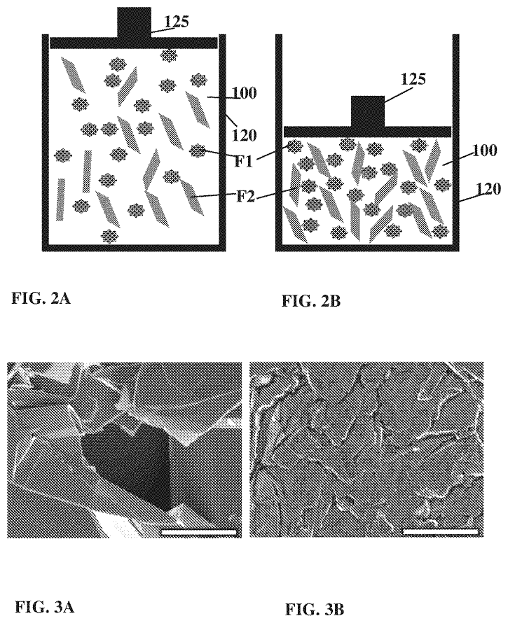

As indicated above, the impact of appropriately selected filler particles on TC is enhanced according to the present technique, by applying pressure on the polymeric mixture. This is exemplified in FIGS. 2A and 2B illustrating pressurizing a mixture of the polymer resin and fillers according to some embodiments of the present technique. FIGS. 2A and 2B show mixture of polymeric resin 100 and a plurality of filler particles of two types F1 and F2 placed in a frame 120. The frame 120 may generally be configured to determine the shape of the resulting element. At least one side of the frame 120 includes, or is configured to include a piston 125, enabling to pressurize the mixture. In this connection FIG. 2A shows the mixture within the frame 120, prior to application of selected pressure, and FIG. 2B shows the polymer mixture during or after application of external pressure using piston or weight 125. It should be noted, that the volume of the mixture may be reduced in response to the pressure, as well as filler-to-filler gap and air voids content within the mixture, as exemplified in FIG. 2B, not to scale with respect to volume change of the mixture.

Scanning electron microscope (SEM) images of the polymeric material (after hardening) are exemplified in FIGS. 3A and 3B. FIG. 3A shows SEM image of hardened polymeric element carrying graphite flakes and graphene nanoparticles after solidification without applying external pressure on the mixture. FIG. 3B shows SEM image of polymeric elements formed from similar mixture, where the wet mixture was placed under pressure prior to hardening. In this example the pressure equals 250 bar. As shown in FIG. 3B, the filler-to-filler gaps are substantially negligible, and typically below 20 nm. Additionally, microscopic air voids, shown in FIG. 3A, as black region, are minimized, and are eventually not present in the final element. More specifically, the resulting element shows surface void density below 8%, and preferably, below 4%.

By applying external pressure on the polymeric mixture and minimizing the filler-to-filler gap and air voids in the solid polymer structure, the resulting structure exhibits improved thermal conductivity, generally exceeding 13 W/mK, and typically in the range of 13-27.5 W/mK. By reducing the filler-to-filler gap and air voids content in the resulting polymeric member, the technique of the present invention yields reduction in phonon scattering within the material, increasing the characteristic phonon transport. This enables improved heat transfer across the member.

Appropriate selection of filler and filler size may also affect thermal conductivity of the composite material. Small-size fillers, having typical dimension below 1 micron, generally possess relatively large surface area and, therefore, high filer-to-filler and filler-to-matrix interfacial contacts. Increased interface and contact points between different materials may increase phonon scattering and thus, reduce thermal conductivity by limiting phonon transport. Accordingly, the present technique preferably utilizes filler particles having relatively large size. More specifically, the present technique preferably utilizes filler particles exhibiting average dimensions greater than 15 micrometers, thus having less interfacial contacts resulting in heat conduction enhancement. For example, graphite flake particles may be used, having average lateral dimension in the range of 15-250 micrometers, and preferably 20-250 micrometers. Graphene particles may be selected with lateral dimensions in the range 1-50 micrometers, and preferably 1-25 micrometers.

As indicated above, the present technique may further utilize relatively high filler loading ratio, or filler concentration. The significant amount of filler particle relative to the epoxy resin is an additional factor for thermal conductivity variations, as well as other properties of the polymer material, unlike improvement in mechanical properties or electrical conductivity, where relatively low filler loading ratios are used. The inventors of the present technique have found that thermal conductivity improvement is efficiently provided with filler loading ratio exceeding 20 wt % to obtain substantial TC increase. Furthermore, the thermal conductivity is improved to desired levels greater than 15 W/mK, when loading ratio is greater than 55 wt %, and typically between 55 wt % and 80 wt %.

It should be noted, that generally, high filler loading ratios are known to generate significant increase in viscosity, or workability, of the polymeric mixture. This may lead to trapped air bubbles/voids in the composite member, limiting its strength, and thus, reducing thermal conductivity and mechanical performance of the composite. However, the present technique resolves this issue by applying external pressure on the wet blend, as indicated above. The pressure causes filler particle to arrange with limited filler-to-filler gap and allows the composite material to solidify with substantially no air voids, allowing improved workability even at high filler loading ratios. For example, when using anisotropic graphene platelets as filler particles, the workability limit is a dominant factor in loading ratio and parameters of the composite material. Generally, workability limit may be at 10 wt % loading ratio for graphene platelets, where the limit is greater for isotropic graphite flakes. Compression of the wet mixture allows the epoxy resin “to settle” between the filler particles, and effectively removes the workability limit, allowing high loading ratios of both isotropic and anisotropic filler particles.

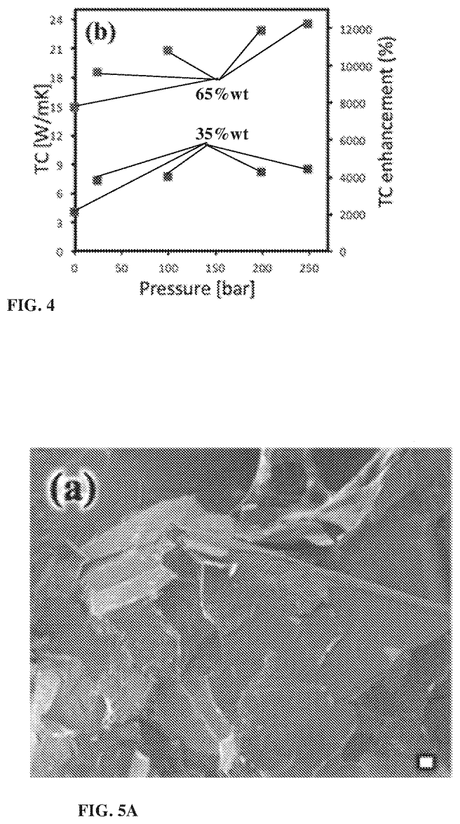

Reference is made to FIG. 4, showing measured thermal conductivity for composite polymeric members produced according to the present technique, using different pressure levels and filler loading ratios of 35 wt % and 65 wt %. As it is shown, at minimal pressure, the filler particles reach improved thermal conductivity over that of the epoxy resin, i.e. about 4 W/mK for 35 wt % loading and about 15 W/mK for 65 wt % filler loading. Additional pressure applied on the wet mixture increased the thermal conductivity up to about 24 W/mK for the composite material, using 65 wt % filler loading ratio and pressure of 250 bars, applied on the wet mixture. This result indicates TC enhancement by 12000%, with respect to that of the intrinsic epoxy resin.

To exemplify the present technique, the inventors have conducted a series of experiments producing composite polymeric members using selected filler properties and pressure levels. In the following, the composite material was based on epoxy resin including diglycidyl ether of bisphenol A, hardened by polyether triamine Selected amounts of filler particles including graphene platelets (e.g. grade H-GnPs with lateral dimension of 15 μm), boron-nitride nanoplatelets (BNNP) and graphite flakes were used.

Exemplifying composite material with relatively low total filler concentrations, i.e. filler loading ratio of about 35 wt %, the fillers (i.e., GF, GnP or BNNP) and the epoxy matrix were placed in a planetary centrifugal mixer at 2000 rpm. The mixing container revolves both around the center and around its own axis, allowing two contradictory simultaneous forces to thoroughly mix the dispersed fillers in the epoxy resin. Two zirconia balls (10 mm in diameter) were added to the mixing container to enhance the mixing process, and removed after mixing. The obtained blend (mixture) was further mixed in high sheer mixer during 10 min at 1000 rpm. During the mixing, hardening material was added at a ratio of 0.4 gr of the hardening material (crosslinker) for each gram of epoxy. The mixture was placed in vacuum oven for 10 min at 80° C. to remove air bubbles within the composite bulk. The composites were then cast into silicone molds, exemplifying 30×30×7.5 mm element, and cured for 20 h at 80° C. In composite samples with high total filler concentrations, i.e. filler loading ratio greater than 35 wt %, the fillers were added gradually (e.g. 1 gr at a time) to the epoxy resin, while being mixed during 5 minutes between filler's additions. This technique was used to allow mixing of high amount of filler particles, that may be limited due to reduced workability of the mixture. Samples that were compressed under selected pressure levels were cast in a hydraulic press under selected pressure levels prior to curing.

Thermal conductivity of the samples was measured by a thermal constants analyzer based on a Transient Plane Source (TPS) technique. The method utilizes a transiently heated plane sensor, which consists of an electrically conducting pattern in the shape of a double spiral. This spiral is sandwiched between two thin sheets of an insulating material (Kapton). When performing a TC measurement, the plane Hot Disk sensor is fitted within the two composite samples. While heating up, the sensor measures the temperature increase inside the sample over time. The time-dependent change in temperature is used to calculate the TC of the measured material. The measurements were conducted in air at 25° C.

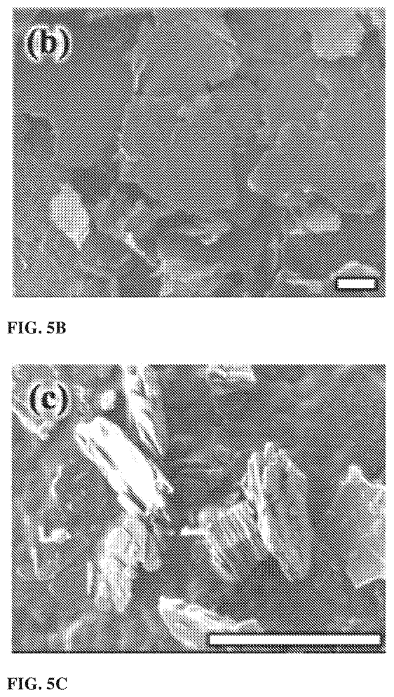

The filler particles are shown in SEM images in FIGS. 5A to 5C. FIG. 5A shows graphite flakes, FIG. 5B shows graphene platelets and FIG. 5C shows boron nitride particles. These images were obtained by high-resolution cold field emission gun SEM operated in secondary electron mode at 3 kV. The filler specimens, prior to mixing with the epoxy resin, were prepared by gently spreading a small amount of filler particles powder on a sticky conductive carbon tape. The filler dimensions were determined by SEM imaging and statistically analyzed indicating graphite flakes with lateral dimension greater than 100 μm in FIG. 5A; graphene platelets with lateral dimension below 20 μm in FIG. 5B; and BNNP with lateral dimension below 5 μm in FIG. 5C. The scale bar in FIGS. 5A to 5C indicates 10 μm length. Generally, the present technique may utilize graphite flakes having average lateral dimension in the range of 20-250 micrometers; graphene platelets having average lateral dimension in the range of 1-25 micrometers; and/or BNNP with lateral dimension in the range of 1-10 micrometers.

As indicated above, the thermal conductivity of polymer-based composites loaded with single or multiple fillers (e.g. GF, Graphene nano-platelets (GnP) and boron nitride nano-platelets (BNNP)) may be affected by selected fillers and filler loading ratio. Generally, thermal conductivity of the filler particles is important parameter for enhancing thermal conductivity of the resulting polymer-based composite. Additional filler parameters include dispersion quality in the polymer and size of the filler particles. The technique of the present invention utilizes selection of filler particles based on thermal conductivity, dispersion parameters in the polymer and size, and further utilizes selected pressure application on mixture of the epoxy resin and fillers to enhance thermal conductivity.

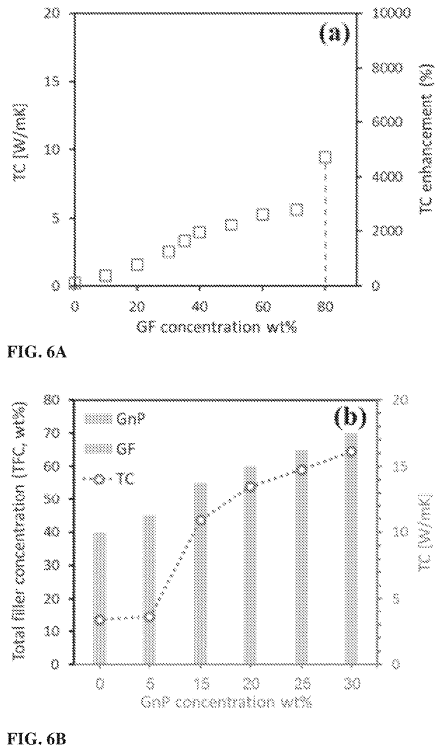

Reference is made to FIGS. 6A and 6B showing thermal conductivity measure on samples prepared with different filler loading ratios. This composite samples were prepared without applying pressure on the mixture, and are brought to elucidate the differences in thermal conductivities of the composite materials. FIG. 6A shows TC data associated with samples having different loading ratios of graphite flakes up to 80 wt %, FIG. 6B shows TC measurements of samples having 40 wt % loading ratio of graphite flakes and additional amounts of graphene platelets. As shown, increasing the amount of filler particles having high thermal conductivity, enhances the thermal conductivity of the resulting material. Further, as shown in FIG. 6B, the use of two or more different filler particles provides further enhancement in the thermal conductivity of the resulting composite material using lower total filler loading ratio of about 70 wt %.

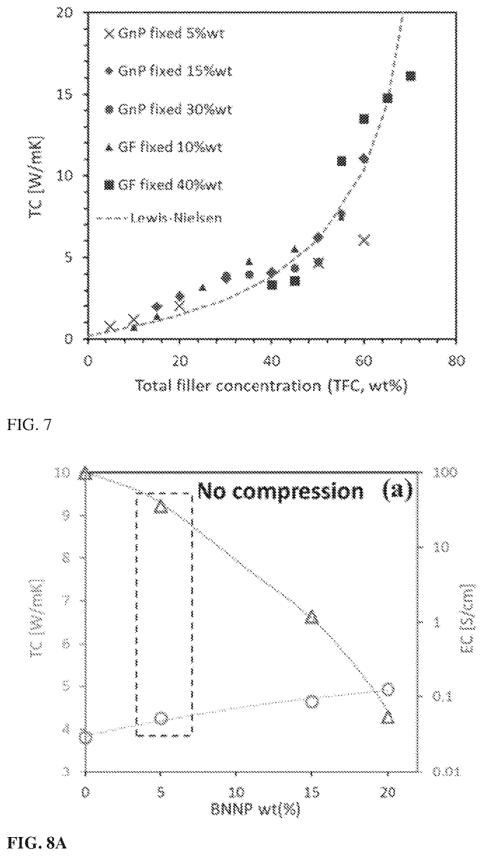

To further demonstrate the TC enhancement and properties thereof, several composite elements were prepared using different filler concentrations. FIG. 7 shows thermal conductivity measurement for epoxy-based hybrid composites including graphite flakes and graphene platelets fillers, at various concentration of fillers. In these examples various combinations of graphite flakes and graphene platelets were measured, where one filler type is in fixed concentration and the other filler varies between the measurement series. Conflating these samples of hybrid composites, including graphite flakes and graphene platelets, one can indicate a trend of thermal conductivity enhancement that fits the Lewis-Nielsen model marked by dashed line.

The Lewis-Nielsen provides a model for thermal conductivity behavior in composite material given by

$$k = {k}_{m} ( \frac{1 + A \cdot B \cdot {v}_{f}}{1 - B \cdot {v}_{f} \cdot ψ} ) ; \{ B = \frac{{k}_{f} / {k}_{m} - 1}{{k}_{f} / {k}_{m} + A} ; ψ = 1 + {v}_{f} ( \frac{1 - {φ}_{m}}{{φ}_{m}^{2}} ) \} \qquad ( equation 1 )$$

Where k is the effective thermal conductivity of the composite, kₘ and k_{f} are the thermal conductivity values of the matrix and the filler, respectively, v_{f} is the total filler volume fraction (calculated from the filler weight fraction), φₘ is the maximum packing fraction of the dispersed particles and A relates to the filler's aspect ratio and their orientation with respect to thermal conduction flow direction. The parameter A is determined from extrapolation, according to the GF aspect ratio, and φₘ was found to be 0.7.

Generally, it can be concluded from FIGS. 6A and 6B and FIG. 7 that the use of two or more different fillers, specifically graphite flakes and graphene platelets, yields high hybrid efficiency in thermal conductivity. Generally, allowing the epoxy resin and filler mixture to cure without applying pressure thereon, is limited to workability limit depending on the filler particles type. Furthermore, these measurements show thermal conductivity enhancement of up to ca. 16 W/mK at the workability limit.

As indicated above and exemplified in FIG. 4, the inventors of the present invention have found that applying pressure on the wet mixture of epoxy resin and fillers results in further enhancement in thermal conductivity of the so-formed polymeric composite material. For example, non-compressed composite with 65 wt % TFC providing thermal conductivity of 14.8 W/mK, as shown in FIG. 6B, may be enhanced to 27.5 W/mK by applying pressure of 250 bar on the wet mixture Similar trend is indicated at different filler loading rations. Thus, the use of selected graphitic fillers at selected loading ratio may be used for enhancing thermal conductivity, while additional pressure applied on the blend, as described above, may provide thermal conductivity to exceed 13 W/mK, and preferably, in some configurations to exceed 16 W/mK.

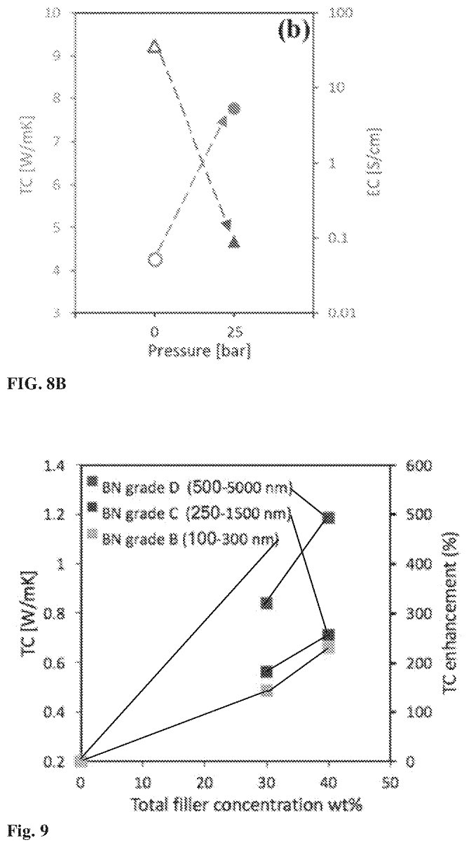

The graphitic fillers used herein (i.e. graphene platelets (GnP) and graphite flakes (GF)) provide both enhanced thermal conductivity, as well as enhanced electrical conductivity. However, in some applications, such as potting or encapsulation, it may be preferred to use electrically insulating composite material having high thermal conductivity. To that end, the present technique utilizes boron nitride nanoplatelets (BNNP) as additional filler to reduced electrical conductivity. BNNP particles generally have intrinsic thermal conductivity of about 300 W/mK, and electrical conductivity measure below 10⁻⁸ S/cm. Boron nitride particles may be used as alternative filler to graphite flakes. FIGS. 8A and 8B show thermal (circles) and electrical (triangles) conductivity measured on composite samples using BNNP filler at different loading ratios. The samples used in these measurements include graphene platelets at loading ratio of 30 wt % and BNNP at varying loading ratios. FIG. 8A shows thermal and electrical conductivities measured on sample articles formed without applying pressure on the mixture, FIG. 8B shows similar measurements on samples cured after applying external pressure on the wet blend, as described above.

As shown in FIG. 8A the use of BNNP as filler results in sharp decrease in the electrical conductivity and minor increase in the thermal conductivity. When applying pressure on the mixture, as shown in FIG. 8B, the thermal conductivity may be enhanced up to ca. 8 W/mK (for composite sample with 30 wt % graphene platelets and 5 wt % BNNP under 25 bar. The same composite produced without applying pressure prior to curing, is characterized by TC of ca. 4 W/mK. The electrical conductivity, on the other hand, is reduced by applying pressure on the wet blend, in this example, from ca. 40 S/cm to ca. 0.1 S/cm.

Reference is made to FIG. 9, exemplifying effects of BNNP filler particle size on thermal conductivity enhancement. In this example, different samples were prepared without compression and by using BNNP fillers of different particle sizes, including grade D with sizes between 500 nm and 5000 nm, grade C with sizes between 250 nm and 1500 nm and grade B with sizes between 100 nm and 300 nm. As shown, large-sized BNNP fillers provide increased thermal conductivity. This trend is maintained when the sample is prepared in accordance with the previously described technique, by applying external pressure to compress the epoxy and filler blend prior to curing.

Thus, the present technique provides polymeric article and method for fabrication of composite articles, possessing dramatically enhanced thermal conductivity, as compared to intrinsic thermal conductivity of the epoxy resin used. The present technique utilizes selection of filler particles and selected concentration of such filler particles mixed with epoxy resin, and further utilizes applying pressure on the mixture, in order to provide enhancement in thermal conductivity of the resulting composite article.

1. A method for manufacturing polymeric material article, the method comprising providing polymeric resin, providing selected amount of filler material, mixing filler material into the polymeric matrix to provide a polymeric filler mixture, compressing said polymeric filler mixture under pressure in the range of up to 350 bar, and curing said polymeric filler mixture to provide stable polymeric material.

2. The method of claim 1, wherein said pressure range is greater than atmospheric pressure.

3. The method of claim 1, wherein said pressure range between 20 bar and 350 bar.

4. The method of claim 1, further comprising mixing hardening material into the said polymeric filler mixture.

5. The method of claim 1, further comprising placing the said polymeric filler mixture in low pressure condition for removing air voids prior to compressing the said polymeric filler mixture.

6. The method of claim 1, wherein said filler material comprises carbon based filler material.

7. The method of claim 6, wherein said carbon based material comprises at least one of graphite flakes and graphene platelets.

8. The method of claim 6, wherein said carbon based material comprises graphene platelets having average lateral dimension in the range 1-25 micrometer.

9. The method of claim 6, wherein said carbon based material comprises graphite flakes having average lateral dimension in the range 20-250 micrometer.

10. The method of claim 1, wherein said filler material comprises Boron-Nitride particles, thereby providing reduced electrical conductivity.

11. The method of claim 1, wherein said selected amount of filler material is at least 25 wt % with respect to the polymeric resin matrix.

12. The method of claim 1, wherein said selected amount of filler material is in a range between 55 wt % and 80 wt % with respect to the polymeric resin matrix.

13. The method of claim 1, providing thermosetting polymeric element having thermal conductivity exceeding 13 W/mK.

14. The method of claim 1, providing polymeric element having thermal conductivity in the range of 13-30 W/mK.

15. The method of claim 1, providing thermosetting polymeric element having thermal conductivity exceeding 16 W/mK.

16. A composite member comprising hardened mixture comprising epoxy resin and one or more types of filler particles, the composite member is characterized by having average filler to filler particle gap below 20 nm and substantially does not have air voids therein.

17. The composite member of claim 16, wherein said composite member is formed by applying pressure on wet mixture of the epoxy resin and one or more types of filler particles.

18. The composite member of claim 16, wherein said composite member is formed by applying pressure in the range of 20 bar to 350 bar on wet mixture of the epoxy resin and one or more types of filler particles.

19. The composite member of claim 16 wherein said mixture further comprises hardening material provided for initiating hardening of the epoxy resin.

20. The composite member of claim 16, wherein said one or more types of filler particles comprise filler particles selected from: graphite flakes, graphene platelets and boron nitride particles.

21. The composite member of claim 16, wherein said one or more types of filler particles comprise filler particles comprising graphite flakes having average lateral dimension in the range of 20-250 micrometers.

22. The composite member of claim 16, wherein said one or more types of filler particles comprise filler particles comprising graphene platelets having average lateral dimension in the range of 1-25 micrometers.

23. The composite member of claim 16, having thermal conductivity exceeding 13 W/mK.

24. The composite member of claim 16, having thermal conductivity exceeding 16 W/mK.

25. The composite member of claim 16 comprising epoxy resin and two or more different types of filler particles.

26. The method of claim 1, wherein said providing selected amount of filler material comprises providing selected amounts of two or more different types of filler particles, thereby enhancing hybrid efficiency in increase of thermal conductivity.
